(19) United States
(12) Patent Application Publication
(10) Pub. No.: US 2024/0008644 A1
(43) Pub. Date: Jan. 11, 2024

(54) SHELF SYSTEM COMPRISING A MARBLE SHELF

(71) Applicant: BAUCE BRUNO & C. S.R.L., Cavaion Veronese (VR) (IT)

(72) Inventors: Alessandro BAUCE, Montebello Vicentino (VI) (IT); Davide BAUCE, Montebello Vicentino (VI) (IT)

(21) Appl. No.: 18/251,525

(22) PCT Filed: Nov. 2, 2021
(86) PCT No.: PCT/IB2021/060123

§ 371 Date: May 2, 2023

(30) Foreign Application Priority Data
Nov. 2, 2020 (IT) 102020000026095

(51) Int. Cl. A47B 96/02; F16M 13/02; A47B 96/06

(52) U.S. Cl. CPC A47B 96/024; F16M 13/025; A47B 96/021; A47B 96/06

(57) ABSTRACT

Disclosed is a shelf system including a marble shelf and an associated support system. The shelf system improves aesthetics by avoiding the use of visible supports.

The present invention refers, in general, to a shelf system with a marble shelf. More particularly, it relates to a shelf system comprising a marble shelf and an associated support system.

As is well known, various support systems are used for the application of shelves to a wall, of which the most commonly used is one or more exposed brackets.

If the shelf is made of marble or stone, the use of visible brackets is avoided in order to achieve the optimum aesthetic result, which is the prerogative of using marble.

To this end, in order to fix a marble shelf to a wall, it is usually necessary to carry out the fixing during the construction of the wall itself, inserting the shelf between the bricks.

Alternatively, it is necessary to carve out a seat in the wall in which to insert the shelf and secure it with the use of adhesives. The wall must in any case be finished, particularly in the part of the visible hole not occupied by the shelf, but from which the adhesive is visible.

In other words, in order to fix a marble shelf to a wall, it is necessary either to carry out the work when building the wall, or to intervene heavily in the wall that has already been built, then having to carry out at least some finishing operations.

In both cases, specialised personnel are required, which is costly and time-consuming.

The purpose and function of the present invention is to provide a shelf system with a marble shelf, which overcomes the problems of the known technique.

A further scope of the invention is to provide a corbel system which enables a marble corbel to be fixed to a wall in a simple and fast manner.

A further scope of the present invention is to provide a corbel system that allows a marble corbel to be attached to a wall without the need for heavy work on the wall, thus avoiding the intervention of skilled personnel.

A further scope of the invention is to provide a shelf system that allows a marble shelf to be fixed to a wall without the use of visible supports, guaranteeing a high aesthetic effect.

These and other purposes are achieved by a shelf system comprising a marble shelf and a support system for fixing the marble shelf with at least one of its faces in contact with at least one wall.

In particular, in the at least one face of the marble shelf abutting the wall, at least one groove is obtained and the support system comprises a profile with at least one fixing means for fixing the profile to the wall, the groove being of a shape homologous to the profile, so that, once the profile is fixed to the wall, the shelf is coupled to the profile by means of an adhesive.

Thanks to the configuration of the shelf system, the assembly of a marble shelf to a wall is practical and fast, as it is sufficient to make one or more holes in a wall, through which one or more profiles are fixed to which, in turn, the marble shelf will be fixed.

The shelf system is characterised by the fact that the support system comprises a metal sheet including the profile and at least two protrusions.

It is therefore easy to obtain the support system from a common metal sheet, thus reducing the cost and complexity of the entire shelf system.

Advantageously, the support system can be made in one piece, so that unwanted edges or steps are avoided.

Furthermore, the profile can be rectangular, so that it fits comfortably into the groove in the marble shelf.

Advantageously, the profile and the two or more protrusions can all be arranged on the same plane, so that the entire support system consists of just the metal sheet with a well-defined perimeter profile.

In addition, the two or more projections may be arranged in line with, or slightly within, the two ends of the rectangular profile.

Advantageously, the perimeter profile of the support system i.e. the metal sheet can be made by one or more of the following processes: blanking, stamping, laser cutting, water cutting.

Further features and details of the invention may be better understood from the following description, which is given by way of non-limiting example, as well as from the accompanying drawing board in which:

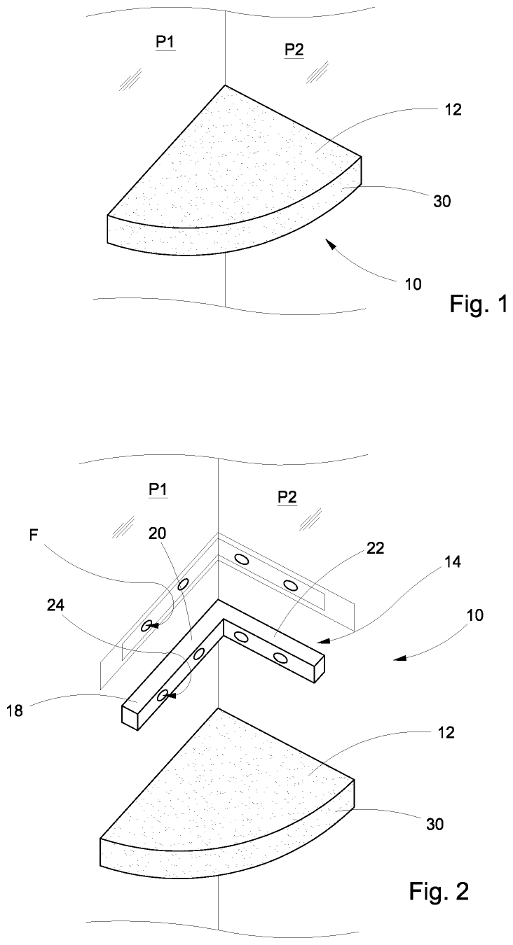

FIG. 1 is a perspective view of a shelf system according to the invention fixed to a wall;

FIG. 2 is an exploded perspective view of the bracket system according to the invention of FIG. 1, comprising a marble bracket and a first support system;

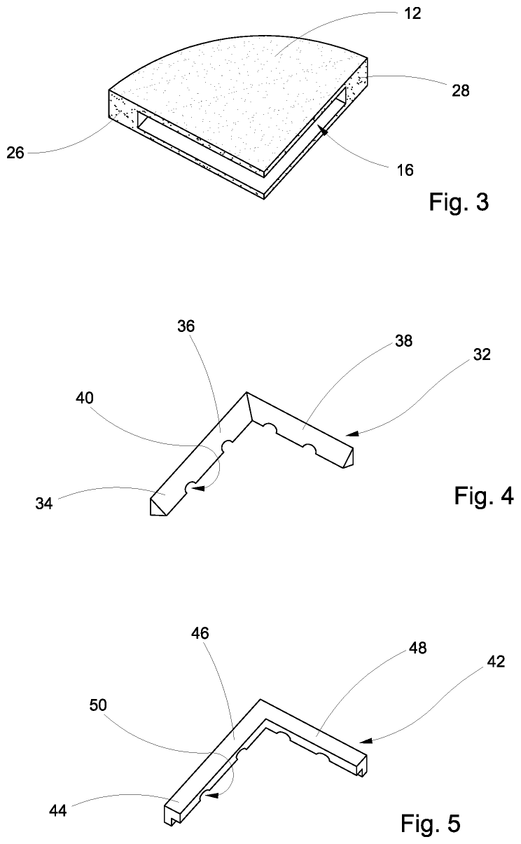

FIG. 3 is a perspective view of the marble shelf of FIG. 2, seen from the opposite side;

FIGS. 4, 5 are perspective views of a second support system and a third support system, useful for respective shelf systems according to variants of the invention;

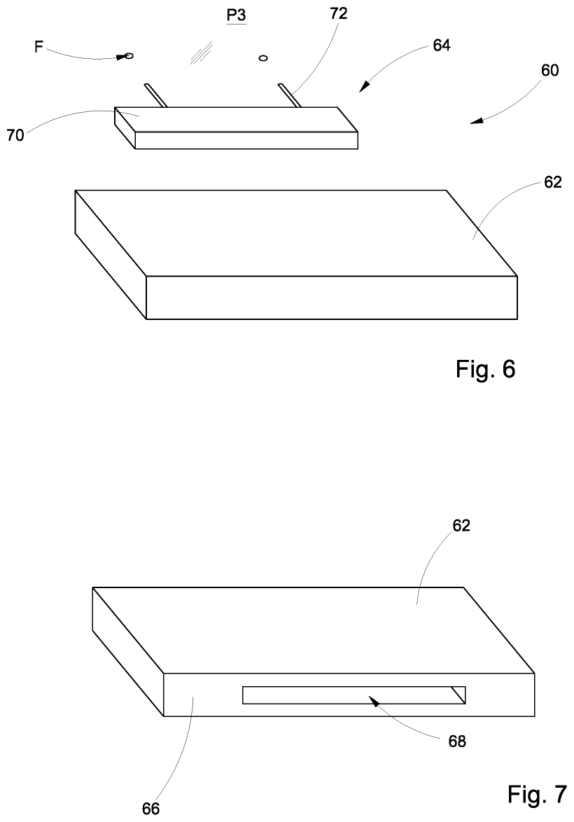

FIG. 6 is an exploded perspective view of a bracket system according to a variant of the invention, comprising a marble bracket and a fourth support system;

FIG. 7 is a perspective view of the marble shelf of FIG. 6, viewed from the opposite side;

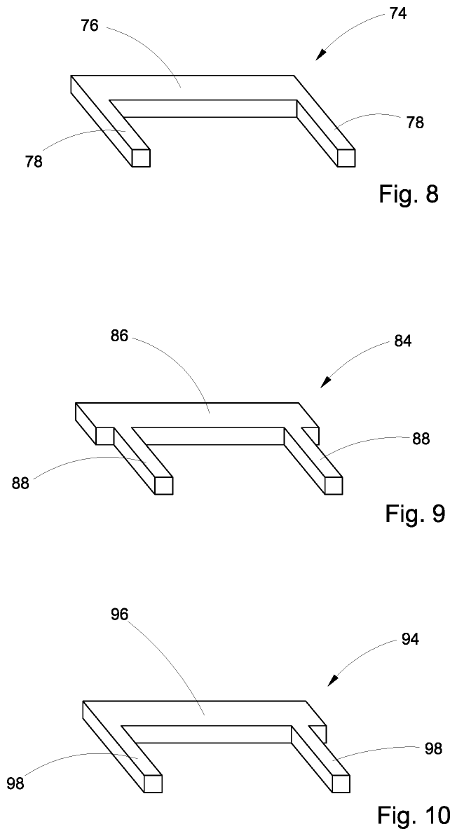

FIGS. 8, 9 and 10 are perspective views of, respectively, a fifth, a sixth and a seventh support system, useful for respective corbel systems according to variants of the invention.

With reference to FIGS. 1, 2, 3, 10 indicates a shelf system comprising a marble shelf 12 and a first support system 14, a system suitable for being fixed to the corner formed by a first wall P1 and a second wall P2 which are orthogonal to each other.

The marble shelf 12 has a quarter-circle shape and, as shown in FIG. 3, a groove 16 is cut into it.

The support system 14 comprises a corner profile 18, i.e. “L” shaped, formed by a first portion 20 and a second portion 22 orthogonal to each other and having a rectangular cross section.

Four holes 24 are cut in the corner profile 18, of which, for ease of reading, only one is indicated in FIG. 2. Precisely, two holes are cut in the first portion 20 of the corner profile 18 and two holes in the second portion 22 of the corner profile 18.

The groove 16 has a form homologous to the corner profile 18 and therefore develops on the two faces 26, 28 of the marble shelf 12 which are in contact with the walls P1 and P2.

Furthermore, the groove 16 only develops on the two faces 26, 28, without affecting the visible outer edge 30 of the marble shelf 12.

In order to assemble the shelf structure 10, object of the invention, first of all four holes F are drilled in the walls P1 and P2 (for ease of reading only one hole is indicated in FIG. 2), precisely two in the first wall P1 and two in the second wall P2, in the same position and corresponding to the holes 24 drilled in the corner profile 18.

The next step is to fasten the support system 14 to the walls. This involves fastening the angle profile 18 to the walls P1 and P2 using pressure screws or other equivalent fastening methods, if necessary by inserting suitable plugs in the holes F in the walls P1 and P2.

Once the support system 14 has been fixed to the walls P1 and P2, the marble shelf 12 is coupled to the corner profile 18 using adhesive substances such as silicone.

The shelf system 10 according to the invention, thus fixed to the walls P1 and P2, presents only the marble shelf 12 in view, while the corresponding support system 14 is hidden between the same marble shelf 12 and the walls P1 and P2.

The aesthetics of the shelf system 10 is optimal and the fixing of the support system 14 to the walls P1 and P2 is simple and does not require the intervention of specialised personnel.

According to a first variant of the invention, a shelf system analogous to the previously illustrated shelf system 10 may comprise a marble shelf and a second support system 32, illustrated in FIG. 4.

The second support system 32 comprises a corner profile 34, formed by a first portion 36 and a second portion 38 orthogonal to each other and having a triangular-shaped cross-section.

In the corner profile 34, four holes 40 are obtained, of which, for ease of reading, only one is indicated in FIG. 4. Precisely, two holes are obtained in the first portion 36 of the corner profile 34 and two holes in the second portion 38 of the corner profile 34.

The marble shelf to be coupled to the second support system 32 has a groove of a shape homologous to the corner profile 34.

According to a second variant of the invention, a shelf system analogous to the previously illustrated shelf system 10 may comprise a marble shelf and a second support system 42, illustrated in FIG. 5.

The second support system 42 comprises a corner profile 44, formed by a first portion 46 and a second portion 48 orthogonal to each other and having an inverted “L” shaped cross-section.

Four holes 50 are obtained in the corner profile 44, of which, for ease of reading, only one is indicated in FIG. 5. Precisely, two holes are obtained in the first portion 46 of the corner profile 44 and two holes in the second portion 48 of the corner profile 44.

The marble shelf to be coupled to the second support system 42 has a groove of homologous shape to the corner profile 44.

According to a third variant of the invention, illustrated in FIGS. 6 and 7, a shelf system 60 comprises a marble shelf 62 and a third support system 64, and is suitable for attachment to a third wall P3.

The marble shelf 62 has a parallelepiped shape, includes a face 66 suitable to go against the third wall P3 and in which a groove 68 is obtained.

The third support system 64 comprises a linear profile 70 to which two pins 72 are fixed.

The bracket system 60 envisages firstly the creation of two holes F in the wall P3 arranged at a distance equal to that between the two pins 72.

Once the dowels have been inserted in the holes F in the wall P3, the dowels 72 are inserted in the same holes F and the linear profile 70 is fixed to the wall P3.

Then the marble shelf 62 is coupled to the linear profile 70 using adhesives such as silicone.

Also in this case, the shelf system 60 according to a variant of the invention, does not have any visible support systems, with consequent advantages from an aesthetic point of view.

Also from a technical point of view, the coupling of the marble shelf 62 to the wall P3 is even simpler, without the need for the intervention of specialised personnel.

According to further variants of the invention, the shelf system 60 comprises the marble shelf 62 and, alternatively to the third support system 64, has a fourth support system 74 or a fifth support system 84 or a sixth support system 94.

The fourth support system 74, made in a single body by shearing or stamping a metal sheet, comprises a rectangular profile 76 from which two protrusions 78 project, as visible in FIG. 8.

In particular, the two protrusions 78 are arranged at the ends of the rectangular profile 76.

The fifth support system 84, made in a single body by shearing, stamping, laser cutting or water cutting a metal sheet, comprises a rectangular profile 86 from which two protrusions 88 protrude, as visible in FIG. 9.

In particular, the two protrusions 88 are arranged slightly inside the ends of the rectangular profile 86.

The sixth support system 94, made in a single body by shearing, stamping, laser cutting or water cutting a metal sheet, comprises a rectangular profile 96 from which two protrusions 98 protrude, as visible in FIG. 10.

In particular, one of the two protrusions 98 is disposed slightly inside one of the two ends of the rectangular profile 96, while the other is in line with the other end of the rectangular profile 96.

As illustrated in FIGS. 8, 9 and 10, in the fourth support system 74, in the fifth support system 84 and in the sixth support system 94 the respective profile 76, 86, 96 and the corresponding two protrusions 78, 88, 98 are all arranged in the same plane.

Furthermore, the fourth support system 74 or the fifth support system 84 or the sixth support system 94 may also be used to fix a marble shelf in the shape of a quarter moon, to two walls at right angles to each other.

In this case, two grooves are obtained in the marble shelf, in particular on the two faces which will be abutting the two walls, one on each face.

The two grooves are not continuous like the groove 16 illustrated for the shelf system 10 of FIGS. 1, 2, 3.

However, even in the case of a marble shelf in the shape of a quarter moon in which there is a continuous groove 16 in the two faces, as in FIG. 3, it is possible to use the fourth support system 74 or the fifth support system 84 or the sixth support system 94, fixing a rectangular profile to each of the two faces which make a rebate on each wall to which the shelf is to be fixed.

Further variations are possible and are to be considered within the scope of protection; for example, the shape of the elements used as the support system may vary, depending also on the application purposes of the bracket system itself.

1. Bracket system comprising a marble bracket and a support system suitable for fixing the marble bracket with at least one face thereof to the at least one wall, wherein in the at least one face of the marble bracket which goes into the wall, at least one groove is obtained and wherein the support system comprises a profile with at least one fixing means suitable for fixing the profile to the wall, the groove being of a form homologous to the profile, so that, once the profile is fixed to the wall, the shelf is coupled to the profile by means of an adhesive, wherein the support system comprises a metal sheet including the profile and at least two projections.

2. The bracket system according to claim 1, wherein the support system is made as a single body.

3. The bracket system according to claim 1, wherein the profile is rectangular.

4. The bracket system according to claim 1, wherein the profile and the at least two projections are all arranged in the same plane.

5. The bracket system according to claim 1, wherein two protrusions are arranged at respective ends of the rectangular profile.

6. The bracket system according to claim 1, wherein two protrusions are arranged slightly inside the respective ends of the rectangular profile.

7. The bracket system according to claim 1, wherein a protrusion is disposed slightly inside one of the ends of the rectangular profile, while another protrusion is in line with the opposite end of the rectangular profile.

8. The bracket system according to claim 1, wherein the metal sheet comprises a perimeter edge defining the profile and the at least two protrusions, said perimeter edge being obtained by one or more of the following processes: blanking, stamping, laser cutting, water cutting.

9. Bracket system according to claim 2, wherein the profile is rectangular.

10. The bracket system according to claim 2, wherein the profile and the at least two projections are all arranged in the same plane.

11. The bracket system according to claim 3, wherein the profile and the at least two projections are all arranged in the same plane.

12. The bracket system according to claim 2, wherein two protrusions are arranged at respective ends of the rectangular profile.

13. The bracket system according to claim 3, wherein two protrusions are arranged at respective ends of the rectangular profile.

14. The bracket system according to claim 4, wherein two protrusions are arranged at respective ends of the rectangular profile.

15. The bracket system according to claim 2, wherein two protrusions are arranged slightly inside the respective ends of the rectangular profile.

16. The bracket system according to claim 3, wherein two protrusions are arranged slightly inside the respective ends of the rectangular profile.

17. The bracket system according to claim 4, wherein two protrusions are arranged slightly inside the respective ends of the rectangular profile.

18. The bracket system according to claim 2, wherein a protrusion is disposed slightly inside one of the ends of the rectangular profile, while another protrusion is in line with the opposite end of the rectangular profile.

19. The bracket system according to claim 3, wherein a protrusion is disposed slightly inside one of the ends of the rectangular profile, while another protrusion is in line with the opposite end of the rectangular profile.

20. The bracket system according to claim 4, wherein a protrusion is disposed slightly inside one of the ends of the rectangular profile, while another protrusion is in line with the opposite end of the rectangular profile.
